(19) United States
(12) Patent Application Publication
(10) Pub. No.: US 2003/0092488 A1
(43) Pub. Date: May 15, 2003

(54) Visual feedback system in game controller

(75) Inventor: Chiu-Hao Cheng, Chung Ho City (TW)

Correspondence Address: BACON & THOMAS, PLLC, 625 SLATERS LANE, FOURTH FLOOR, ALEXANDRIA, VA, 22314

(73) Assignee: ZEROPLUS TECHNOLOGY CO., L.T.D., Chung Ho City (TW)

(21) Appl. No.: 10/291,381

(22) Filed: Nov. 12, 2002

(30) Foreign Application Priority Data
Nov. 15, 2001 (TW) 90128309

(51) Int. Cl. A63F 13/00

(52) U.S. Cl. 463/31

(57) ABSTRACT

The visual feedback system of this invention places a display device in between a game console and a game controller. Through video synthesizing circuitry, the display device captures motion signals from the game controller and vibrating signals generated during the game to produce a video signal that can be further combined with the video signal transmitted by the game console. Finally, the video synthesizing circuitry sends the combined video signal to the screen for display. In this way, the user no longer has to keep an eye on the information given by the game controller. Adding to the existing sense of touch provided by the original controller, the user can further experience a visual feedback effect.

### BACKGROUND OF THE INVENTION

1. Field of the Invention

This invention is a type of visual feedback system used in game controllers. More specifically, the visual feedback system places a display device in between the game console and the game controller. Through video synthesizing circuitry, the display device captures motion signals from the game controller and vibration signals generated during the game to produce a video signal that can be further combined with the video signal transmitted by the game console. Finally, the video synthesizing circuitry sends the combined video signal to the screen for display, which creates an enhanced effect of visual feedback.

2. Description of the Prior Art

As electronic technology improves, new systems and new games are constantly being introduced for personal computers and game consoles. Besides faster processing speed and better graphics, game controller design is also being improved in order to meet the needs of new game designs and increase entertainment value.

As to the current technology, at present there exists only game controllers with feedback vibration signals, which allows the user to obtain a sense of touch and interaction as the game progresses. Another prior art is a type of game controller which informs the user of the status of the game by LED light emission. These approaches are limited to visual feedback operation. During a game, the user seldom has the chance to keep an eye on the visual information provided by the game controller. Thus, the desire to control visual feedback information cannot be completely satisfied.

Modern television technology is also improving rapidly. Among the technologies that have been developed is an application regarding volume adjustment or video configuration (brightness, contrast, width, height . . . etc.) by the user directly through the television or indirectly through a remote control. A rectangular status dialog appears on the bottom of the television screen, allowing the user to view and control the current configuration. This is achieved through the video synthesizing circuitry by obtaining configuration from the control circuit and displaying the status dialog on the screen. If the video synthesizing technique is used to display the game status directly on the television screen, the user can easily obtain the information and experience a more realistic visual effect in the game.

The purpose of this invention is to provide enhancement of visual feedback. The control signals between the game console and the game controller are captured and combined into video signals through the video synthesizing circuitry. After combining with the video signal transmitted by the game console, the final video signal can be sent to the screen for display. Adding to the existing sense of touch provided by the controller, the user can further experience visual feedback enhancement.

Another purpose of this invention is to facilitate a visual feedback system with a variable number of display modes selected by the game control.

### SUMMARY OF THE INVENTION

As previous technologies cannot completely satisfy the user in terms of providing visual feedback information, this invention places a visual feedback system in between the game console and the game controller. Through video synthesizing circuitry, the feedback system captures motion signals from the game controller and vibration signals generated during the game to produce a video signal that can be further combined with the video signal transmitted by the game console. Finally, the video synthesizing circuitry sends the combined video signal to the screen for display. In this way, the user no longer has to pay attention to the game controller in order to obtain visual feedback information. This not only creates great enhancement of visual feedback, it also immerses the user into a realistic world.

### REFERENCE NUMERALS DESCRIPTION

10—Screen

101—Wheel status bar

102—Accelerator status bar

103—Brake status bar

104—Accelerator and brake status bar

105—Joystick display window

106—Joystick display window

107—Game controller display window

20—Game console

30—Game controller

31—Game controller visual feedback system

32—Wireless transmitter (game controller device)

33—Wheel

34—Joystick

40—Visual feedback system

41—Wireless receiver (game console)

50—Communication interface

60—Control circuitry

70—Color video synthesizing circuitry

71—Control circuitry

72—Video switch

73—Converter circuitry

74—Modulation circuitry

75—Horizontal synchronization signal separation circuitry

76—Vertical synchronization signal separation circuitry

77—On/off switch

78—Synchronizer

79—Mixer

90—PROG button

100—Wireless transmitter device

110—Wireless receiver device

120—Multiple buttons

130—Control circuitry

140—Control circuitry

150—Control circuitry

160—Control circuitry

170—Control circuitry

### DETAILED DESCRIPTION OF THE INVENTION

Please refer to Figure A and Figure B for the screen produced by this invention. When the user adjusts volume or video configuration (such as brightness, contrast, width, height . . . etc) directly through the television or indirectly through a remote control, a rectangular dialog box appears on the bottom of the television, allowing the user to view the current configuration. There are two kinds of dialog box. One kind progresses from left to right on the screen and is mostly used when adjusting volume. The other kind splits itself in half and is mostly used when adjusting video configuration such as brightness, contrast, width, height . . . etc. The control circuitry in the television will record the configuration set by the user and display the information on the television screen after passing through a video synthesizing circuitry.

Next, please refer to FIG. 2 for the schematic of the color video synthesizing circuitry (70). The circuit contains: one control circuitry (71), one video switch (72), one converter circuitry (73), one color modulation circuitry (74), one horizontal synchronization signal circuit (75), one vertical synchronization signal circuit (76), one on/off switch (77), one synchronizer (75), and one mixer (MIX 79). The circuit functions as follows:

The control circuitry (71) receives display information from control circuitry (60). At the same time, it receives H_sync signal from the horizontal synchronization circuit and V sync from the vertical synchronization circuit. The video switch (72) is actually a two-stage switch monitored by the control circuitry (71). When the control circuitry (71) provides a high voltage (Logic 1), the video signal (Video in) from the game console is transmitted directly to the screen (Video out) for display. When the voltage is low (Logic 0), the synthesized signal to be displayed is transmitted to the screen (Video out) for display. The converter circuitry (73) transforms the three primitive colors RGB into (R-Y), (B-Y), and Y signals. The RGB colors are obtained from the control circuitry (71) after passing through D/A converters. The color modulation circuit (74) modulates (R-Y), (B-Y) and Y signals from the converter circuitry (73) into a video signal by a color subcarrier frequency of 3.579545 MHz. It is important to note that there are two types of television standards, the NTSC and PAL, each with a different color subcarrier frequency. The implementation used here follows the NTSC standard since this is the standard used in Taiwan. If the PAL standard is required, simply adjust the frequency to 4.4331876 MHz. The horizontal synchronization signal separation circuit (75) extracts the horizontal synchronization signal (H_sync) from the mixed signal and transmits it to the control circuitry (71). The same applies for the vertical synchronization signal (V_sync). The on/off switch (77) is used for toggling between different display modes. The synchronizer (78) is used to synchronize H_sync and V_sync signals. The mixer (79) integrates the signal from the synchronizer (78) and the video signal produced by the control circuitry (71) mentioned earlier. Then the video switch (72) sends the signal (Video out) to the screen for display.

Please refer to FIG. 3 for the grayscale video synthesizing circuit. The grayscale video synthesizing circuit includes: one control circuitry (71), one video switch (72), one horizontal synchronization signal separation circuit (75), and one on/off switch (77). The circuit functions as follows:

The control circuitry (71) receives display information from external electronic circuit (60). At the same time, it receives an H sync signal from the horizontal synchronization signal separation circuit. The video switch (72) is a two-stage switch monitored by the control circuitry (71). When it receives high voltage (Logic 1), the video signal (Video in) from the game console (2) is passed directly to the screen (Video out) for display without any modification. When the voltage is low (Logic 0), the synthesized video signal is sent to the screen. The horizontal synchronization signal separation circuit (75) extracts the horizontal signal (H_sync) from the video signal and sends it to the control circuitry (71). The on/off switch (77) is used to monitor the control circuitry (71) in order to switch to different modes.

Please refer to FIG. 4 for the electronic schematic diagram of the first improved implementation example. The visual feedback system (4) includes: one communication interface (50), one control circuitry (60), and one video synthesizing circuitry (70). The communication interface can be used to obtain signals between the game console (20) and the game controller (30). Therefore, control circuitry (60) can also rely on the communication interface (50) to extract motion signals from the game controller and vibrating signals generated during the game. The display information can then be transferred to the video synthesizing circuitry (70) through a data bus. The video synthesizing circuitry can process either color or grayscale images and can synchronize the preset configuration information into the video signal (Video in) from the game console (20). Subsequently, the synthesized video signal will be transmitted to the screen (Video out) for display.

Next, please refer to FIG. 5 for the electronic schematic diagram of the second improved implementation example. This implementation applies the game controller device (30) to a visual feedback system (31). The main components include: one communication interface (50), one control circuitry (130), one video synthesizing circuitry (70) and multiple buttons (120). Among these, the communication interface (50), the control circuitry (130), and multiple buttons (120) carry out all the functions that the game controller device needs.

In addition, the control circuitry (130) links directly to the game console (20) through the communication interface (50). On the one hand, the control circuitry (130) carries out communication between the game controller device (30) and the game console (20). At the same time, it also receives the input information from the user and the vibration signals produced during the game. Then, the display information can be transferred to the video synthesizing circuitry (70) through a data bus. The video synthesizing circuitry can process either color or grayscale images and synchronize the preset configuration information into the video signal (Video in) from the game console (20). Subsequently, the synthesized video signal will be transmitted to the screen (10) for display (Video out). The multiple buttons are (120) are used for input from the user in order for the game to progress.

Next, please refer to FIG. 6 for the electronic schematic diagram of the third improved implementation example. The schematic shows implementation of a wireless visual feedback system combined with a wireless game controller. The wireless visual feedback system includes: one wireless transmitter device at the game console (41), and one wireless receiver device at the game controller (32). Specifically, the wireless transmitter device is composed of: one communication interface (50), one control circuitry (140), one video synthesizing circuitry (70), one wireless transmitter (100) and one wireless receiver (110). The wireless game controller device (32) communicates with the wireless device at the game console through the communication interface (50), a wireless transmitter (100), and a wireless receiver (110). Both the transmitter (100) and the receiver (110) are monitored by the control circuitry (140). On the one hand, the control circuitry (140) carries out communication between the game controller device (30) and the game console (20). At the same time, it also receives input information and vibration signals produced during the game from the wireless game controller device via the wireless receiver (110). The display information is then transferred to the video synthesizing circuitry (70) and synchronized into the video signal (Video in) from the game console (20). Subsequently, the synthesized video signal will be transmitted to the screen (10) for display (Video out). The wireless game controller device (32) includes: one control circuitry (150), one wireless transmitter (100), one wireless receiver (110), and multiple buttons (120). The control circuitry (150) controls communication between the game console (20) and both the transmitter (100) and receiver (110), allowing input information from the user to be sent to the wireless device at the console (41). The multiple buttons (120) are used for input from the user in order for the game to progress.

Please refer to FIG. 7 for the electronic schematic diagram of the fourth improved implementation example. One of the implementation examples is a wireless visual feedback system which is able to receive signals from the wireless game controller device (32). The display mode can then be combined into the video signal (Video in) from the game console (20) and sent to the screen (10) for display (Video out). One known wireless game controller device includes: one wireless device at the game console (41) and one wireless device at the game controller (32). Specifically, the wireless device at the game console (41) is composed of: one communication interface (50), one control circuitry (10), one wireless transmitter (100), and one wireless receiver (110). The wireless device at the game controller communicates with the game console (20) through the communication interface (50), the wireless transmitter (100), and the wireless receiver (110). Both the transmitter and the receiver are monitored by the control circuitry (170) where it carries out communication between the wireless game controller device (32) and the game console (20). The wireless game controller device (32) is mainly composed of: one control circuitry (150), one wireless receiver (130), one wireless transmitter (140), and multiple buttons (120). The control circuitry (150) controls communication between the game console (20) and both the transmitter (100) and receiver (110). This allows input information from the user to be sent to the wireless device at the console (41) and the wireless visual feedback system (42). The multiple buttons (120) are used for input from the user in order for the game to progress.

In this implementation example, the wireless visual feedback system (42) includes: one wireless receiver (110), one control circuitry (160), and one video synthesizing circuitry (70). The control circuitry (160) controls the wireless receiver (110) and is able to receive input information from the user through the wireless game controller device (32). Then, the display information can be sent to the video synthesizing circuitry (70), which further synchronizes the preset configuration information into the video signal (Video in) from the game console (20). Subsequently, the synthesized video signal will be transmitted to the screen (10) for display (Video out).

Next, the mechanism that converts control information between the game console and the game controller into display information is described. Please refer to FIGS. 8(A), (B), (C), (D), (E), (F), (G), and (H) for different display modes on the screen (10). Figures (A) to (E) all have a status bar (101) on top that is split in half, showing wheel information. The other two status bars are placed vertically on the two sides of the screen, showing information about the accelerator and the brake. The bars are presented differently, some in smaller boxes, some in long rectangles, and some the same as before but using gradient colors. FIG. 8(F) shows two status bars which are both curved and split in half. The top status bar (101) displays wheel information while the bottom status bar (104) displays accelerator and brake information. The information displayed can be swapped between these two status bars. The difference is that when a status bar shows the accelerator and brake information, it shows accelerator information on one side and brake information on the other side. FIG. 8(G) minimizes the above display modes into a small window (107) that can be placed anywhere on the screen the user desires. FIG. 8(H) is composed of a small window which has the same range as the entire screen. In FIG. 8(H), there are two small windows displaying different modes. One of the windows (105) has eight arrows pointing in different directions and an octagonal structure in the center, which represents the user. Another window (106) is composed of an X-axis and a Y-axis with an octagonal structure in the center, which represents the user. These two windows show information about current screen location and motion vector when the user moves the joystick. They can also be placed anywhere on the screen the user desires. Furthermore, the above display modes can be swapped and shown in semi-transparent modes. These display modes, along with the preset configuration, can be chosen at the time of design and stored conveniently in memory. Please refer to FIG. 9(A), (B), and (C) for step changes (wheel) on the screen. In addition, please refer to FIG. 10(A) for the look up table of wheel (flight joystick) output value and the steps shown on the screen. Please refer to FIG. 10(B) for the look up table of the accelerator and brake output value and the steps shown on the screen. If the status bar (101) in FIG. 9 changes according to the wheel (33), the output value has a range from 000˜128˜255 with a zero position at 128. Status bar (102) changes according to the accelerator with an output range 000˜255 and a zero position at 000. Status bar (103) changes according to the brake with an output range 000˜255 and a zero position at 000. Looking at FIG. 10(A), if the wheel (33) has an output value of 050, which falls in the range 033-064, the step in the middle and its two adjacent steps will illuminate. The brightness intensity on the screen is darkest when the output value is 033 and brightest when the output value is 064. In other words, when the output range is constant, the status bar will become brighter as the output value increases. For more information about the accelerator/brake steps and its brightness intensity, please refer to FIG. 10(B).

FIGS. 9(A), (B), and (C) will be explained in detail now. As FIG. 9(A) illustrates, when the wheel (33), accelerator, and brake are idle, the output values are all at the zero position. Only the middle step in status bar (101) is illuminated; no steps are illuminated in either status bar (102) or status bar (103). In FIG. 9 (B), if the output value is 200 when the wheel (33) turns towards A (right) with the accelerator stepped on, the middle step and the three steps on the right illuminate on status bar (101). When the accelerator output value is 180, six steps in status bar (102) illuminate but no steps in status bar (103) are illuminated. In FIG. 9 (C), if the output value is 050 when the wheel (33) turns towards B (left) with the accelerator released, the middle step and the three steps on the left illuminate on status bar (101). And when the accelerator output value is 088, three steps are illuminated on status bar (102). On the other hand, when the accelerator output value is 100, four steps are illuminated on status bar (102).

Next, please refer to FIGS. 11(A), (B), and (C) for step changes (flight joystick) on the screen. FIG. 11 is actually the small window (105) in FIG. 8 (H). The arrows form an octagonal structure with equally spaced x-axis and y-axis. The cursor in the middle, which represents the user, moves according to the output value of the flight joystick (34). When the cursor moves, two dashed lines appear on the x-axis and the y-axis according to the movement of the flight joystick. As shown in FIG. 11(A), when the flight joystick (34) is idle, the cursor is positioned at the intersection of the x-axis and y-axis. In FIG. 11(B), the cursor moves towards lower right when the flight joystick (34) moves towards D (lower right). The two dashed lines appear on both the x-axis and y-axis and relocate according to the output value of the flight joystick (34). When the flight joystick (34) stops moving, the cursor remains stationary as well. In FIG. 11 (C), the cursor moves left when the flight joystick (34) moves towards G (left). Again, the two dashed lines appear on both the x-axis and y-axis and relocate according to the output value of the flight joystick (34). The XY axes can be replaced by x-axis status bar and y-axis status bar as well. The output range for the flight joystick (34) is 000˜128˜255 with zero position at 128. Please refer to FIG. 10(A) for step changes and the corresponding brightness intensity in wheel (flight joystick). Based on the previous four implementations, the video synthesizing circuitry (70) is able to produce either grayscale or color images in both the non-wireless visual feedback system and the wireless visual feedback system. Different display modes can be placed on the same memory and toggled using the switch (77). The video synthesizing circuitry (7) can be associated with a brightness adjustment button which is used to adjust the brightness level of the screen (10). Furthermore, a transparency adjustment button can also be realized and used to adjust the transparency level of the screen (10). In addition, an ON/OFF switch can be used to activate or deactivate the display mode produced by the visual feedback system. These extra functionalities can be easily implemented by individuals who are familiar with the technology.

Since there is too much information exchanged between the game console (20) and the game controller (30), it is hard for the control circuitry to decide which information to process. For that reason, another purpose of this invention is to add a PROG (programmable) function which can be used to configure the displayed items on the screen (10). This will prevent the control circuitry from not knowing which information to process. Please refer to FIG. 12 for the flow chart of the PROG function. There are two ways to implement the PROG function, one of which is to add a PROG button (100) independently onto the display device (40). Another way is to preset two or more combination buttons. When the user activates the PROG function, procedure 220 determines the type of button being pressed. If the user is operating the game controller (30), procedure 230 will determine the axes change on the controller. The value of axes change must be smaller than 40 or greater than 192 with an output range of 000˜128˜255 and zero position at 128. When the user operates towards the right, the output value will start to increase from 128 to the greatest value, 255. On the other hand, when the user operates towards the left, the output value will start to decrease from 128 to 0. This kind of axes change is used in wheel, flight joystick, or XY axes buttons, etc. If the force applied onto a button needs to be determined, procedure 240 is used. The value of the force applied must be greater than 128 with an output range of 0˜255 and zero position at 000. When the user operates, the output value increases from 0 to the greatest value, 255. This kind of force button is used in accelerator, brake, etc. If the type of button is digital, procedure 250 is used. There are only two output values for a digital button, 0 and 1, with a zero value of 0. The value required for any processing to occur must be 1. Specifically, when the user presses the button, the output value changes from 0 to 1. On the other hand, when the user releases the button, the output value changes from 1 to 0. This kind of digital button is used in start buttons, function buttons, etc. After the type of button is determined, procedure 260 is used to determine if each button being pressed follows its preset values. For example, the axes change must reside between 40 and 192, the value of force applied onto a button must be greater than 128, and the digital button must have a value of 1. If these conditions are not met, procedure 220 will be repeated. Otherwise, procedure 270 is used to set these buttons to the corresponding items on the screen (10). Next, procedure 280 determines if the user has activated the PROG button. If the PROG button is activated, the entire process ends at procedure 290. If this is not true, procedure 220 is repeated again to set the displayed items on the next screen (10).

FIG. 13 shows the actual circuit diagram of the visual feedback system. Please refer to FIG. 13 in conjunction with FIGS. 3 and 4. The actual circuit diagram of the visual feedback system includes: one communication interface (50), one voltage regulator IC 78L05, one horizontal synchronization separation circuitry (75), one microcontroller EM78450_{—}1, one switch (90), one video switch (72), one RCA jack for input signal VIDEO IN, and one RCA jack for output signal VIDEO OUT. The communication interface (50) captures control signal between the game console (20) and the game controller (30). The control signal is then sent to the microcontroller EM78450_{—}1. The voltage regulator IC 78L05 converts the DC voltage (1.5 volt) from the communication interface (50) to a lower DC voltage (5.0 volt) in order to provide the necessary driving voltage for other ICs. The horizontal synchronization separation circuitry (75) is composed of Q1, R1, R2, and C1. The circuitry splits the video signal (Video in) into horizontal synchronization signal (H_sync) and vertical synchronization signal (V_sync). Switch (90) is composed of multiple buttons SW1, SW2, and SW3. It is used as PROG button or a switch for display mode. It can also be used to implement buttons for new functionalities. The microcontroller EM78450_{—}1 implements the control circuitry (71) for control circuitry (60) and video synthesizing circuitry (71). This microcontroller is able to capture control signals through the communication interface (50) and synchronize the preset configuration information into the video signal (Video in) from the game console (20). Subsequently, the synthesized video signal will be transmitted to the video switch (72) and then to the screen (Video out) for display.

After explaining the actual implementation of this invention, individuals who are familiar with the technology can clearly understand, transform, and modify the invention under the restrictions imposed by and in accordance with the essence of the patent application. In addition, the invention is not restricted to the implementations explained in this document.

According to this invention, a visual feedback system used in a game controller places a display device in between the game console and the game controller. Through a video synthesizing circuit, the feedback system captures motion signals from the game controller and vibrating signals generated during the game to produce a video signal that can be further combined with the video signal transmitted by the game console. Finally, the video synthesizing circuit sends the combined video signal to the screen for display. In this way, the user no longer has to pay attention to the game controller in order to obtain visual feedback information. This not only provides great enhancement of visual feedback, it also provides for more effective, more economical usage.

### BRIEF DESCRIPTION OF THE DRAWINGS

The purposes and advantages of this invention can be understood through following diagrams and the corresponding explanation.

FIG. 1(A) and (B) depicts the prior art of this invention.

FIG. 2 depicts the color video synthesizing circuitry diagram of this invention.

FIG. 3 depicts the grayscale video synthesizing circuitry diagram of this invention.

FIG. 4 depicts the electronic schematic diagram of the first improved implementation example.

FIG. 5 depicts the electronic schematic diagram of the second improved implementation example.

FIG. 6 depicts the electronic schematic diagram of the third improved implementation example.

FIG. 7 depicts the electronic schematic diagram of the fourth improved implementation example.

FIG. 8(A), (B), (C), (D), (E), (F), (G), and (H) illustrates different changes as a result of this invention on the screen.

FIG. 9(A), (B), and (C) illustrates the step changes (wheel) on the screen.

FIG. 10(A) shows a look up table for the output value of the wheel (flight joystick) and its corresponding step changes.

FIG. 10(B) shows a look up table for the output value of the accelerator/brake and its corresponding step changes.

FIG. 11(A), (B), and (C) illustrates the step changes on the screen (flight joystick).

FIG. 12 depicts the flow chart for the Program function of this invention.

FIG. 13 depicts the actual circuit diagram of this invention.

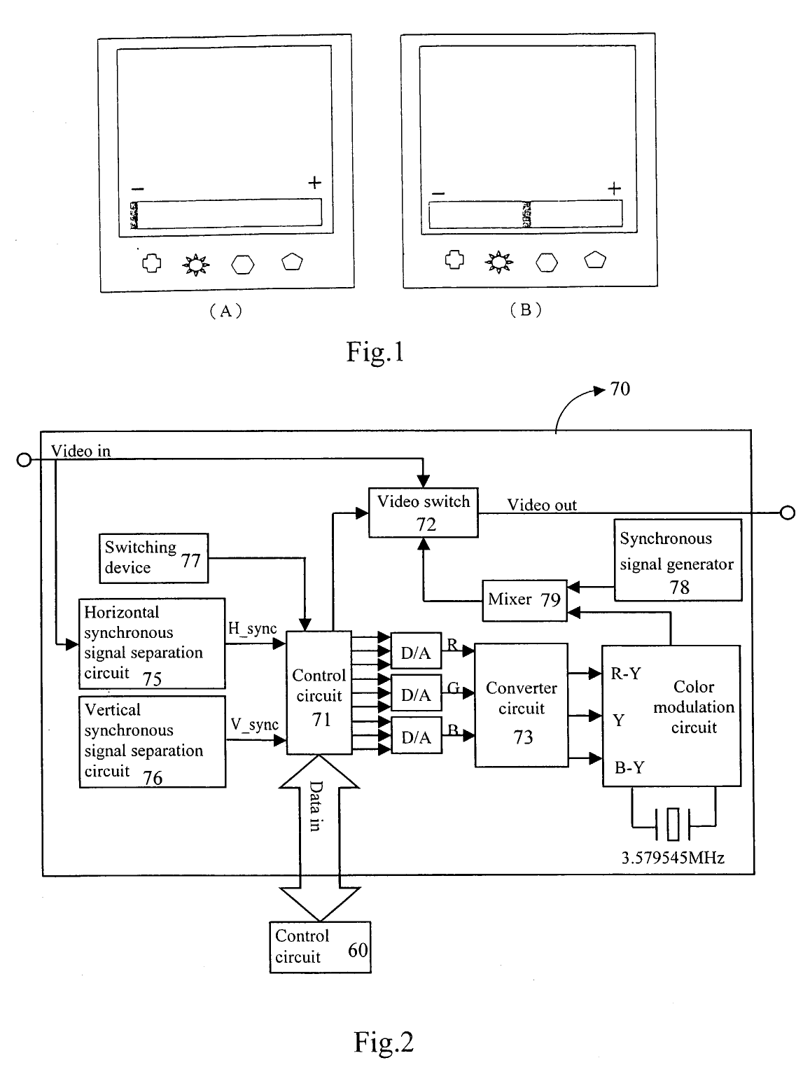

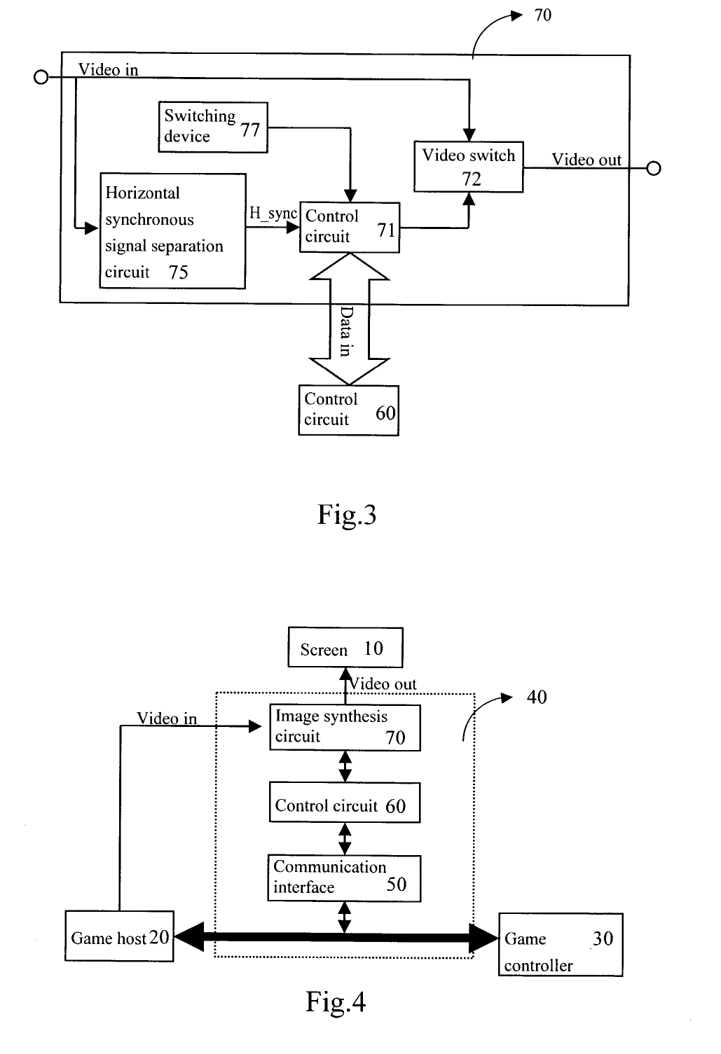

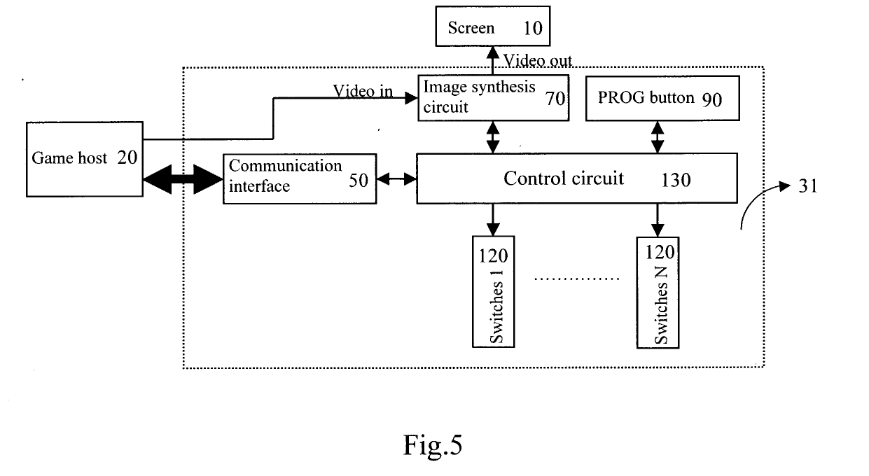

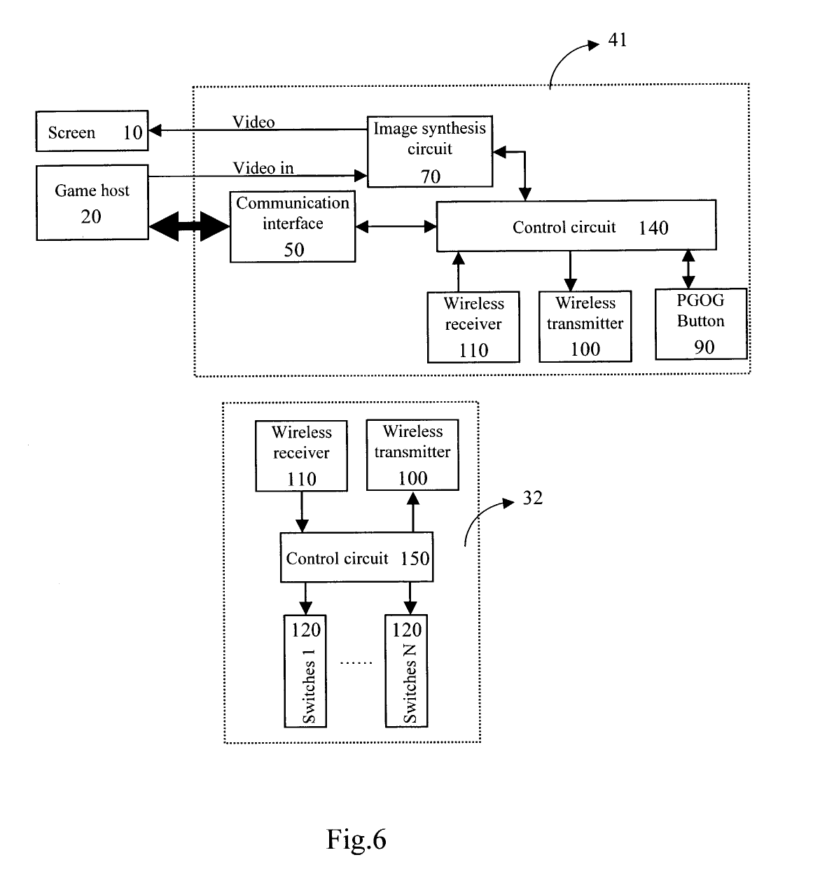

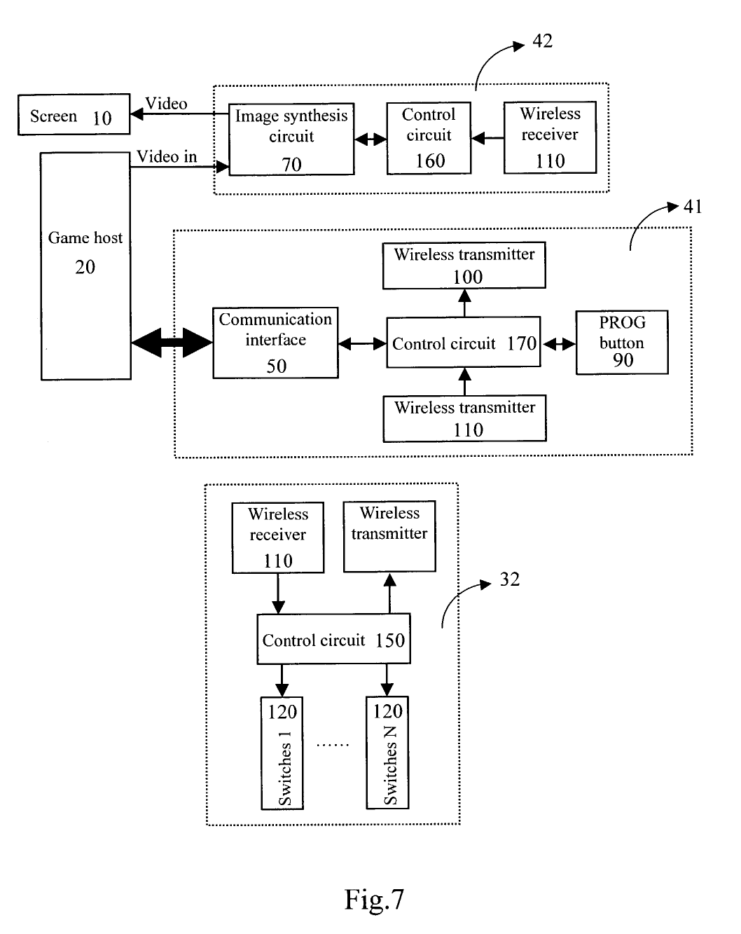

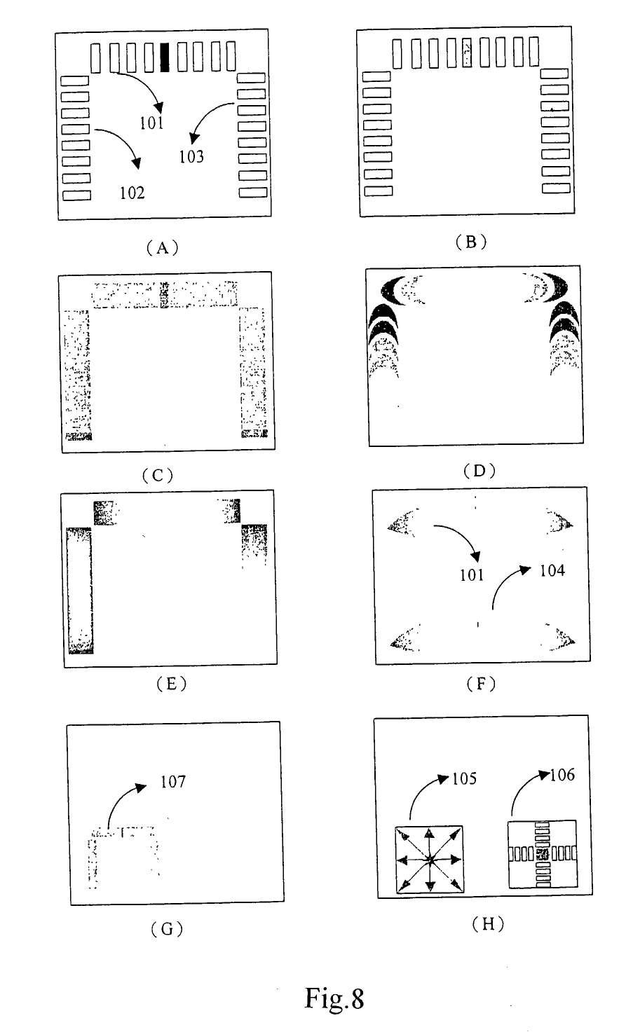

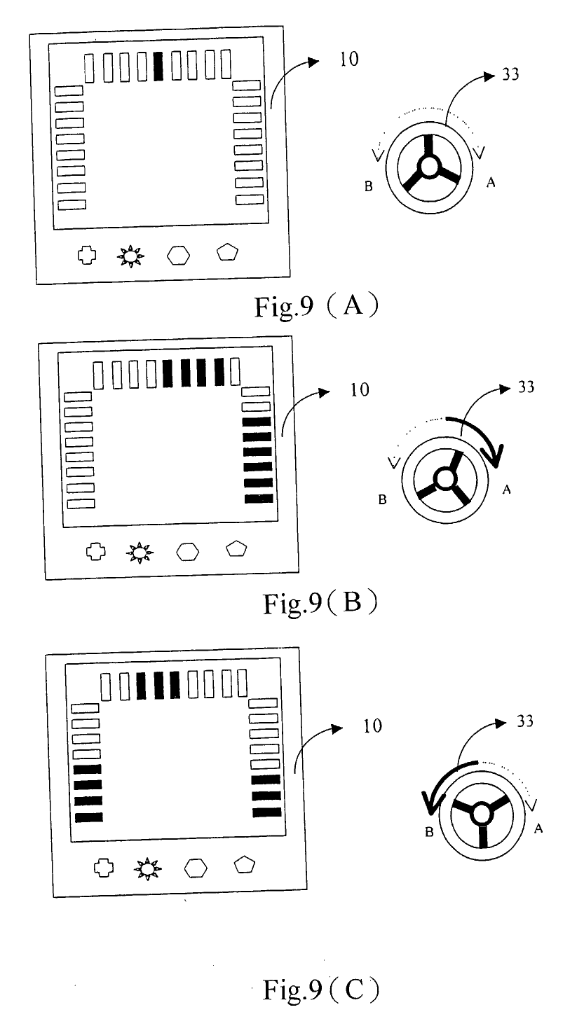

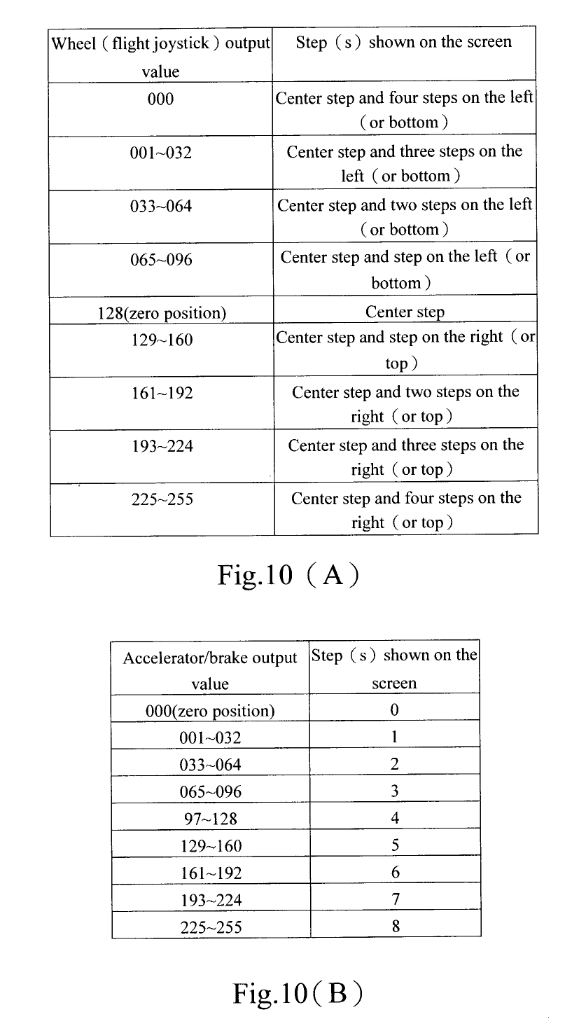

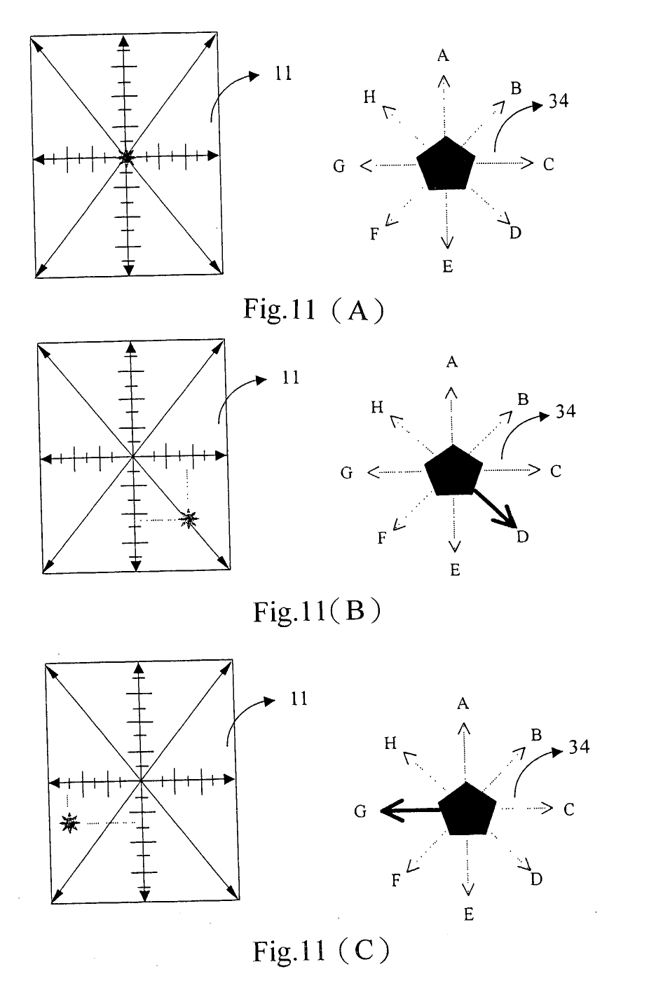

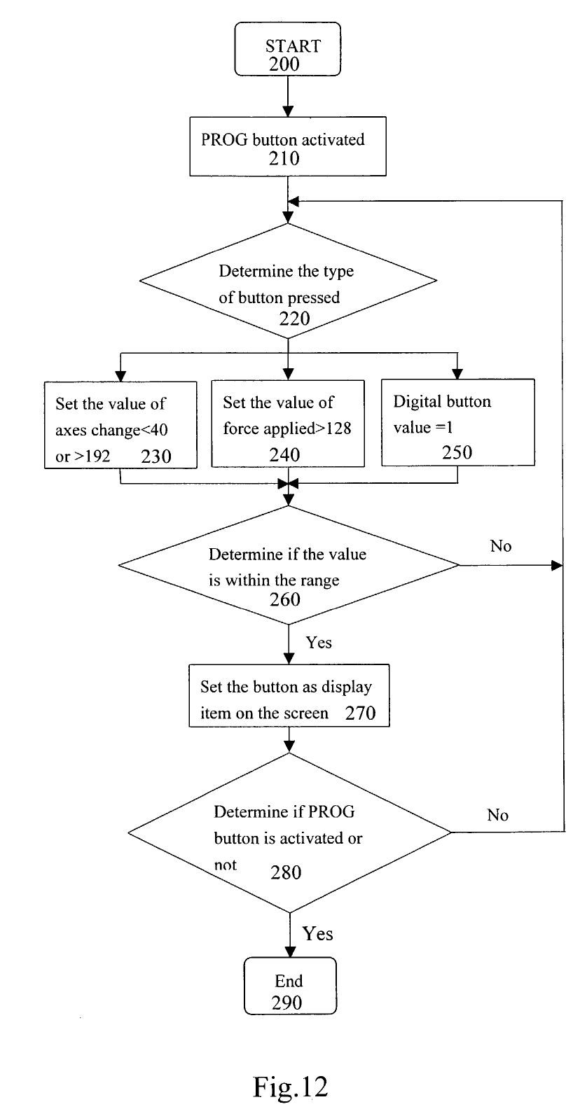

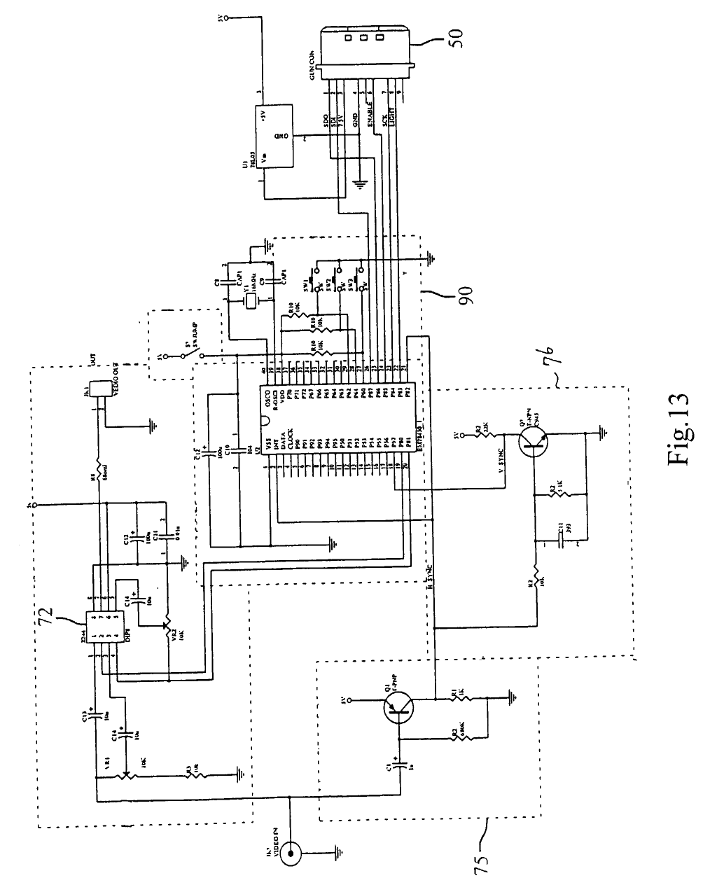

1. A visual feedback system which is connected between a game console and a game controller comprising:
a communication interface which is used to connect the game console and the game controller;
a control circuitry which receives control signals from the game controller though the communication interface in order to convert to preset display mode and display information;
and one video synthesizing circuitry which receives video signals from the game console and display information from the control circuitry and synchronizes the information into the video signal from the game console for screen display.

2. The visual feedback system of claim 1 wherein the game console can be a television entertainment system.

3. The visual feedback system of claim 1 wherein the game console can be a computer gaming system.

4. The visual feedback system of claim 1 wherein different display modes of the video synthesizing circuitry are saved in a memory.

5. The visual feedback system of claim 4 wherein the video synthesizing circuitry is connected to a switch which allows different display modes to be selected.

6. The visual feedback system of claim 1 wherein the video synthesizing circuitry is connected to a brightness adjustment knob which allows the brightness level on the screen to be adjusted.

7. The visual feedback system of claim 1 wherein the video synthesizing circuitry is connected to a transparency adjustment knob which allows the transparency level on the screen to be adjusted.

8. The visual feedback system of claim 1 wherein the video synthesizing circuitry is able to produce color or grayscale images.

9. The visual feedback system of claim 1 wherein a PROG (programmable) function can be added and used to configure the information of display modes.

10. The visual feedback system of claim 9 wherein the PROG function can be a single button.

11. The visual feedback system of claim 9 wherein the PROG function can be comprised of two or more preset buttons on the game controller.

12. The visual feedback system of claim 1 wherein the displayed steps can be determined by the output value of the game controller.

13. The visual feedback system of claim 1 wherein the control signal can be the input motion signal of the game controller or the vibration signal produced during a game.

14. A game controller visual feedback system in conjunction with a game console comprises:
a game controller device which includes:
a communication interface for information exchange between the interface and the game console;
multiple buttons for input signal;
a control circuitry which receives control signals from the game console though the communication interface and converts the control signals and input signals into display information;
and a video synthesizing circuitry which receives video signals from the game console and display information from the control circuitry and
synchronizes the information into the video signal from the game console for screen display.

15. The game controller visual feedback system of claim 14 wherein the game console can be a television entertainment system.

16. The game controller visual feedback system of claim 14 wherein the game console can be a computer gaming system.

17. The game controller visual feedback system of claim 14 wherein different display modes of the video synthesizing circuitry are saved in a memory.

18. The game controller visual feedback system of claim 17 wherein the video synthesizing circuitry is connected to a switch which allows different display modes to be selected.

19. The game controller visual feedback system of claim 14 wherein the video synthesizing circuitry is connected to a brightness adjustment knob which allows the brightness level on the screen to be adjusted.

20. The game controller visual feedback system of claim 14 wherein the video synthesizing circuitry is connected to a transparency adjustment knob which allows the transparency level on the screen to be adjusted.

21. The game controller visual feedback system of claim 14 wherein the video synthesizing circuitry is able to produce color or grayscale image.

22. The game controller visual feedback system of claim 14 wherein a PROG (programmable) function can be added and used to configure the information of display modes.

23. The game controller visual feedback system of claim 22 wherein the PROG function can be a single button.

24. The game controller visual feedback system of claim 22 wherein the PROG function can be comprised of two or more preset buttons on the game controller.

25. The game controller visual feedback system of claim 22 wherein the displayed steps can be determined by the output value of the game controller.

26. A wireless visual feedback system in conjunction with a game console and a wireless game controller, which includes a wireless controller device allowing the input information from the user to be transmitted wirelessly, comprising:
a wireless receiver which receives information entered by the user through the wireless game controller;
a control circuitry which controls the wireless receiver in order to convert the input signal into display information;
and a video synthesizing circuitry which receives video signals from the game console and display information from the control circuitry and synchronizes the information into the video signal from the game console for screen display.

27. The wireless visual feedback system of claim 26 wherein the game console can be a television entertainment system.

28. The wireless visual feedback system of claim 26 wherein the game console can be a computer gaming system.

29. The wireless visual feedback system of claim 26 wherein different display modes of the video synthesizing circuitry are saved in a memory.

30. The wireless visual feedback system of claim 29 wherein the video synthesizing circuitry is connected to a switch which allows different display modes to be selected.

31. The wireless visual feedback system of claim 26 wherein the video synthesizing circuitry is connected to a brightness adjustment knob which allows the brightness level on the screen to be adjusted.

32. The wireless visual feedback system of claim 26 wherein the video synthesizing circuitry is connected to a transparency adjustment knob which allows the transparency level on the screen to be adjusted.

33. The wireless visual feedback system of claim 26 wherein the video synthesizing circuitry is able to produce color or grayscale images.

34. The wireless visual feedback system of claim 26 wherein a PROG (programmable) function can be added and used to configure the information of display modes.

35. The wireless visual feedback system of claim 34 wherein the PROG function can be a single button.

36. The wireless visual feedback system of claim 34 wherein the PROG function can be comprised of two or more preset buttons on the game controller.

37. The wireless visual feedback system of claim 34 wherein the displayed steps can be determined by the output value of the game controller.
